(19) United States
(12) Patent Application Publication
(10) Pub. No.: US 2014/0004748 A1
(43) Pub. Date: Jan. 2, 2014

(54) MULTI-DIRECTION ADAPTER

(71) Applicants: Wang-I YU, JHONGHE (TW); Hung-Chi TAI, JHONGHE (TW); Yung-Chih HUNG, JHONGHE (TW)

(72) Inventors: Wang-I YU, JHONGHE (TW); Hung-Chi TAI, JHONGHE (TW); Yung-Chih HUNG, JHONGHE (TW)

(73) Assignee: ALLTOP ELECTRONICS (SUZHOU) LTD., Taicang City (CN)

(21) Appl. No.: 13/619,401

(22) Filed: Sep. 14, 2012

(30) Foreign Application Priority Data
Jun. 29, 2012 (CN) 201210220357.1

(51) Int. Cl. H01R 27/02; H01R 24/66

(52) U.S. Cl. 439/639; 439/638

(57) ABSTRACT

An adapter includes a PCB, a first connector electrically connecting with the PCB, a second connector electrically connecting with the PCB, a third connector electrically connecting with the PCB, and an insulative cover enclosing the first connector, the second connector, and the third connector. The first connector electrically connects with the PCB via a first direction. The second connector electrically connects with the PCB via a second direction. The third connector electrically connects with the PCB via a third direction. The first direction, the second direction and the third direction are different from one another.

### BACKGROUND OF THE INVENTION

1. Field of the Invention

The present invention relates to an electrical connector, more particularly to an adapter.

2. Description of Related Art

Conventional electrical products can usually be connected to different kinds of electrical equipments to satisfy different users' needs, hence the electrical products are popularly utilized by users due to the easy and convenient utilization thereof. However, the electrical product is not equipped with sufficient receptacles, therefore when the electrical product is to be connected to different electric equipments, the user often needs to repeat the plugging and unplugging action.

With the development of technology, the need to manufacture an adapter with plural receptacles for mating with several complementary plugs simultaneously has to be satisfied to provide easy utilization. However, a conventional adapter is usually inserted into the electric equipment from a single direction, where it has also a relatively larger size. Therefore, it is more difficult for the conventional adapter to be adapted to a low-profile electric equipment having relatively smaller size and lower height.

Hence, it is necessary to improve the conventional adapter to address the problems mentioned above.

### BRIEF SUMMARY OF THE INVENTION

Accordingly, an object of the present invention is to provide an adapter which is suitable to a low-profile electric equipment, and also capable of realizing multi-direction adaption.

In order to achieve the above-mentioned object, an adapter comprises a PCB, a first connector electrically connecting with the PCB, a second connector electrically connecting with the PCB, a third connector electrically connecting with the PCB, and an insulative cover enclosing the first connector, the second connector, and the third connector. The first connector electrically connects with the PCB via a first direction. The second connector electrically connects with the PCB via a second direction. The third connector electrically connects with the PCB via a third direction. The first direction, the second direction and the third direction are different from one another.

The foregoing has outlined rather broadly the features and technical advantages of the present invention in order that the detailed description of the invention that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled perspective view of an adapter in accordance with a first embodiment of the present invention;

FIG. 2 is a partially exploded view of FIG. 1;

FIG. 3 is an assembled perspective view of a first connector of the adapter shown in FIG. 2;

FIG. 4 is an exploded perspective view of the first connector shown in FIG. 3;

FIG. 5 is an assembled perspective view of a second connector of the adapter shown in FIG. 2;

FIG. 6 is a view similar to FIG. 5, but viewed from another aspect;

FIG. 7 is an assembled perspective view of a third connector of the adapter shown in FIG. 2;

FIG. 8 is a view similar to FIG. 7, but viewed from a different aspect;

FIG. 9 is an assembled perspective view of the adapter in accordance with a second embodiment of the present invention; and

FIG. 10 is a partially exploded view of the adapter shown in FIG. 9.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

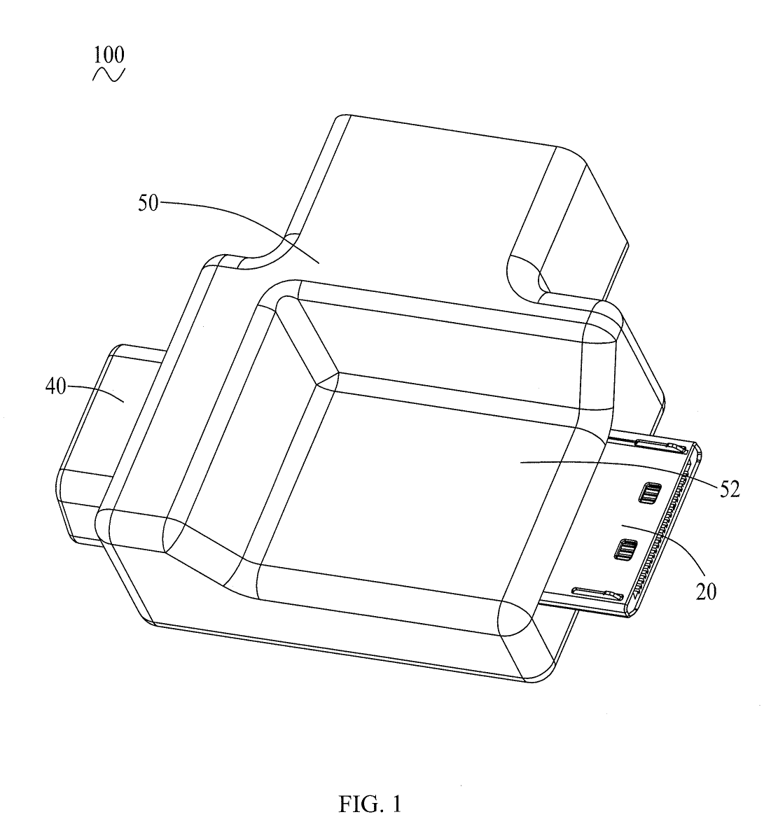

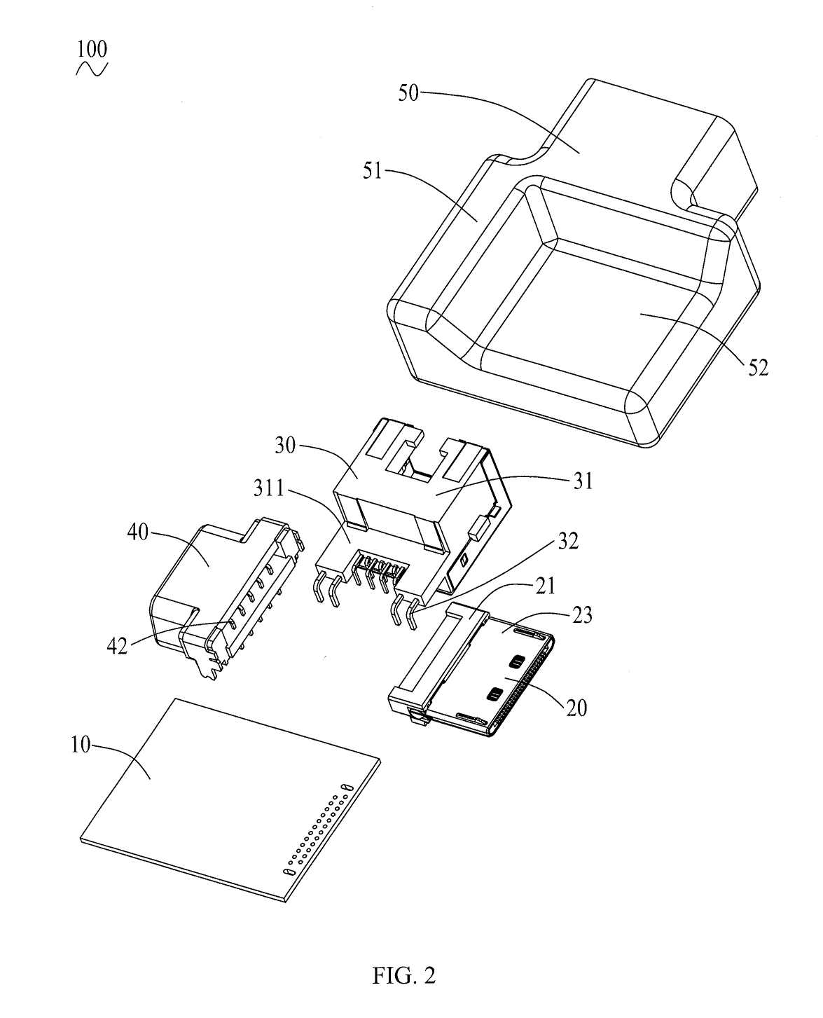

FIGS. 1-2 show an adapter 100 in accordance with a first embodiment of the present invention. The adapter 100 comprises a PCB 10 (Printed Circuit Board), a first connector 20, a second connector 30 and a third connector 40 all electrically connected with the PCB 10. The first connector 20 electrically connects with the PCB 10 along a first direction. The second connector 30 electrically connects with the PCB 10 along a second direction. The third connector 30 electrically connects with the PCB 10 along a third direction. The first, second and third directions are different from one another. The adapter 100 also comprises an insulative cover 50 enclosing the PCB 10, the first connector 20, the second connector 30, and the third connector 40.

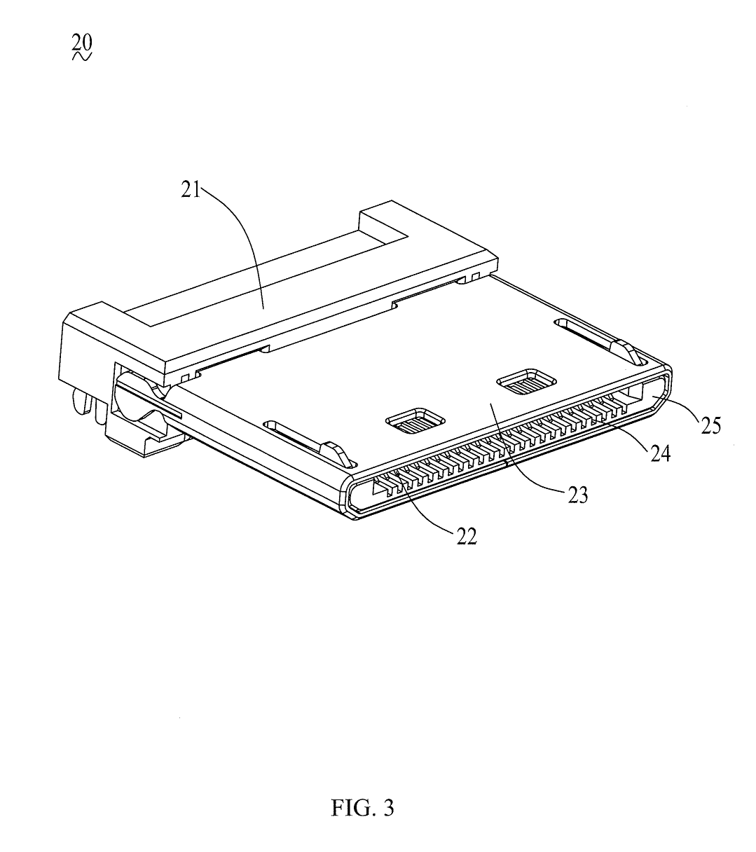

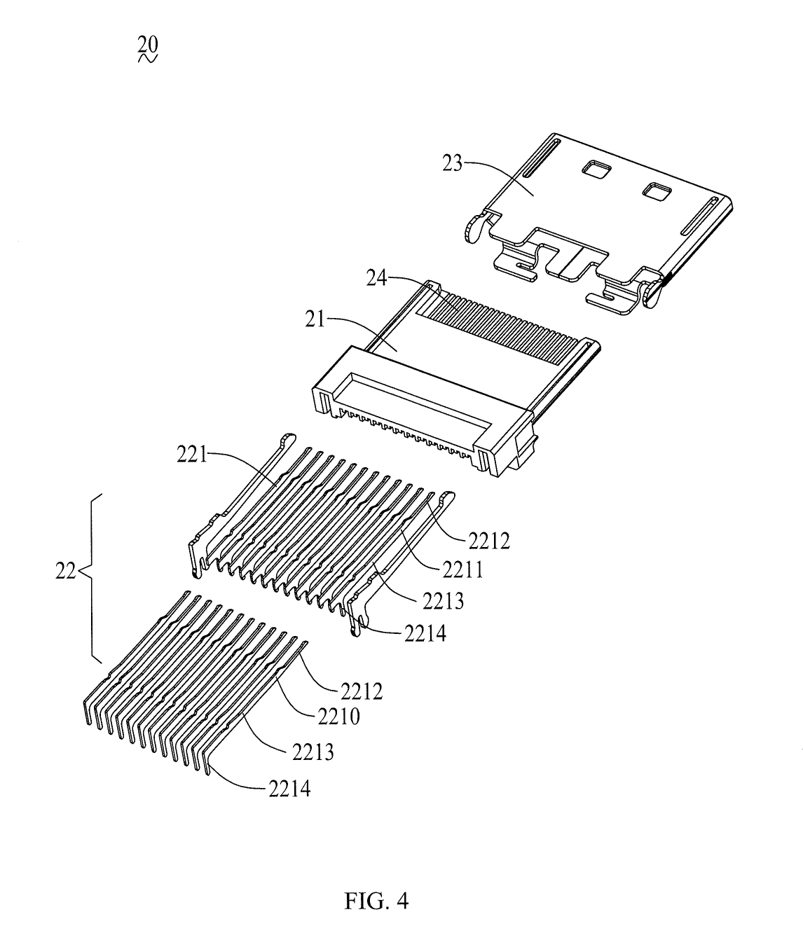

Referring to FIGS. 3-4, the first connector 20 comprises a first insulative housing 21, a plurality of first contacts 22 received in the first insulative housing 21, and a metal shell 23 enclosing the first insulative housing 21 and the first contacts 22. The first insulative housing 21 defines a plurality of contact-receiving slots 24 penetrating therethrough along an insertion direction of the first contacts 22 to accommodate the first contacts 22.

In the first embodiment of the present invention, the first contacts 22 comprise twenty-four first signal contacts 221 soldered to the PCB 10. The twenty-four first signal contacts 221 are grouped into a first group of first signal contacts 2210 and a second group of first signal contacts 2211 alternatively arranged with the first group of first signal contacts 2210. Each group of first signal contacts 2210, 2211 has twelve first signal contacts 221. Each first signal contact 221 comprises a contacting portion 2212 received in the contact-receiving slot 24 and partially exposed to the outside, a termination portion 2214 exposed beyond the first insulative housing 21 to be soldered to the PCB 10, and an intermediate portion 2213 connecting the contacting portion 2212 and the termination portion 2214.

The only difference between the first group of first signal contacts 2210 and the second group of first signal contacts 2211 is: the termination portion 2214 of the first group of first signal contacts 2210 bends substantially vertically from a free end of the intermediate portion 2213, while the termination portion 2214 of the second group of first signal contacts 2211 bends substantially vertically from one side of the intermediate portion 2213 which has a certain distance to the free end thereof.

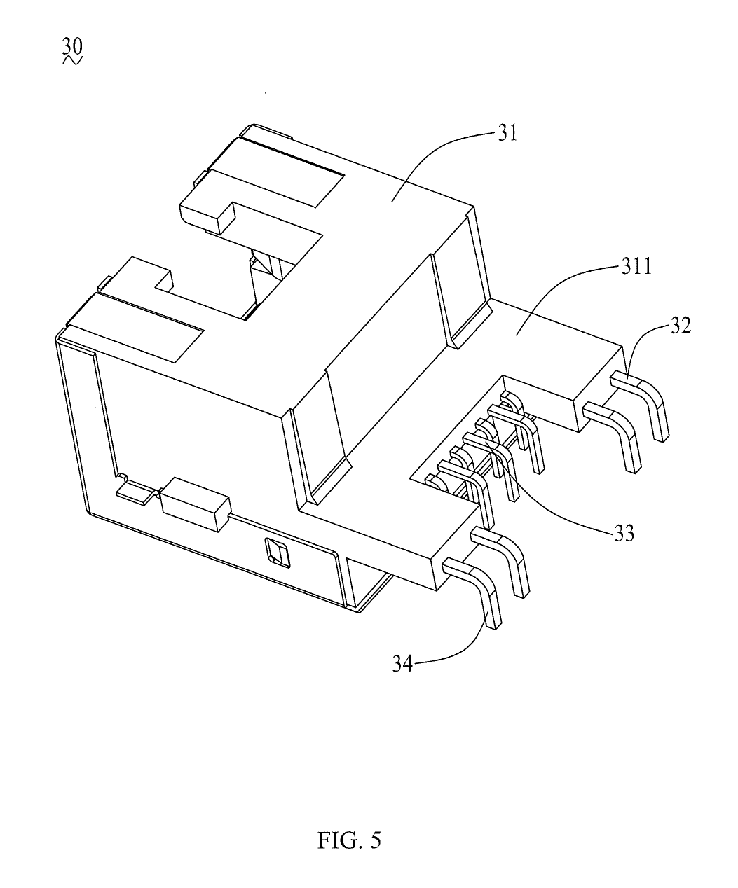

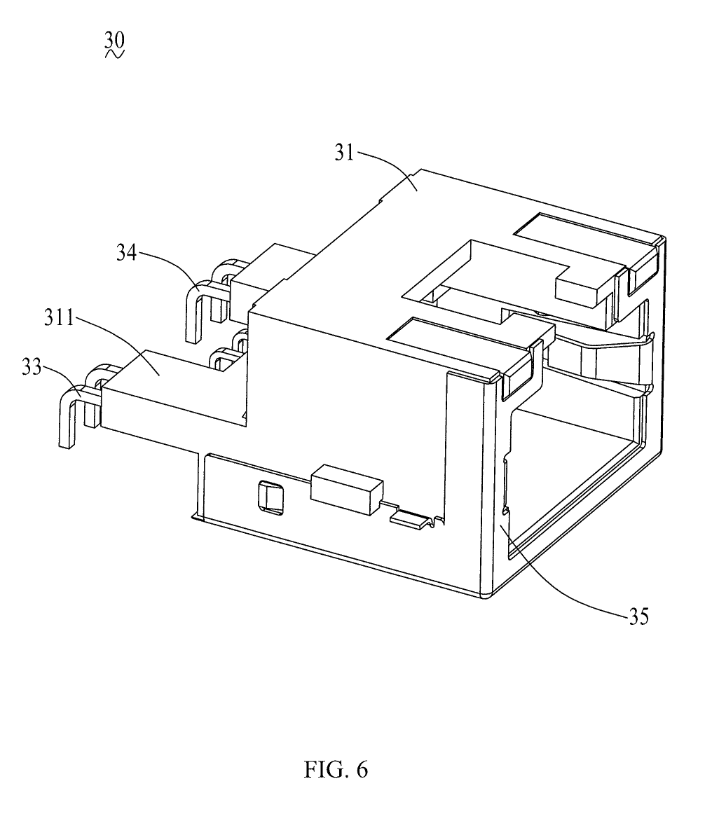

Referring to FIGS. 5-6 and FIG. 2, the second connector 30 comprises a second insulative housing 31 and a plurality of second contacts 32 received in the second insulative housing 31. In the first embodiment of the present invention, the second contacts 32 comprise twelve second signal contacts 33 which are soldered to the PCB 10. The second insulative housing 31 forms a protrusion 311 protruding rearwardly from a rear edge thereof. The pins 34 of the twelve second signal contacts 33 extend from a rear edge of the protrusion 311 to be soldered to the PCB 10. The second signal contacts 33 electrically connect with the first group of firs signal contacts 2210 for transmitting signals to the first connector 20.

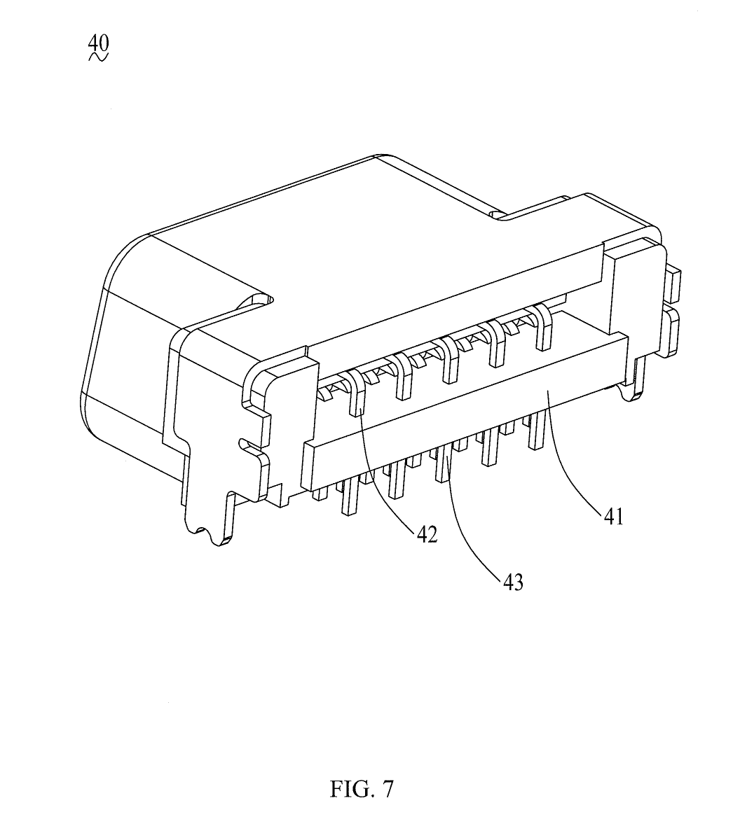

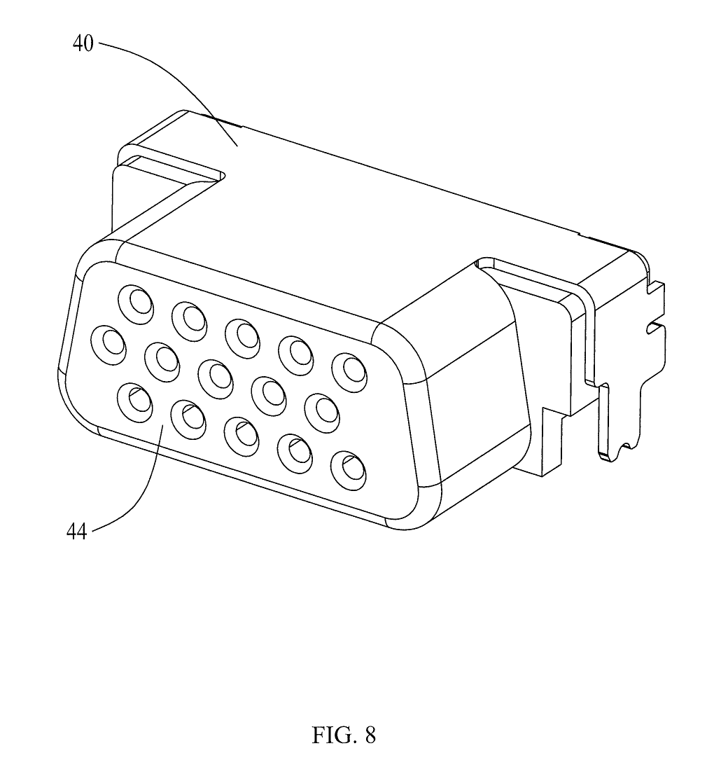

Referring to FIGS. 7-8 in conjunction with FIG. 2, the third connector 40 comprises a third insulative housing 41 and a plurality of third contacts 42 received in the third insulative housing 41. In the first embodiment of the present invention, the third contacts 42 comprise twelve third signal contacts 43 which are soldered to the PCB 10. The third signal contacts 43 are electrically connected with the second group of first signal contacts 2211 for transmitting signals to the first connector 20.

Referring to FIGS. 3, 6 and 8, the height of the first connector 20 is lower than those of the second connector 30 and the third connector 40. The first connector 20 has a flat first mating port 25, the second connector 30 has a rectangular second mating port 35, while the third connector 40 has a trapezoidal third mating port 45. In the first embodiment of the present invention, the first connector 20 is a flat connector, the second connector 30 is an RJ 45 connector, while the third connector 40 is a VGA connector.

Referring to FIG. 2, the insulative cover 50 comprises a top surface 51, and a recess 52 recessed downwardly from the top surface 51. Thus, the height of the insulative cover 50 enclosing the first connector 20 is lower than the insulative cover 50 enclosing the second connector 30 and the third connector 40 to reduce the height of the adapter 100 to be capable of mating with a low-profile electrical equipment (not shown).

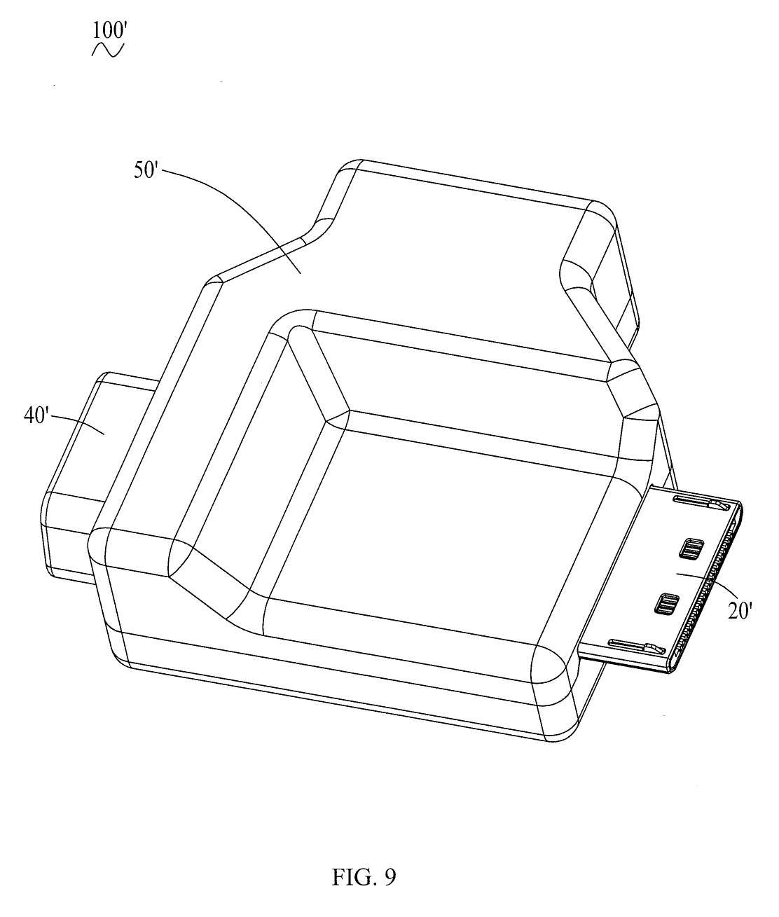

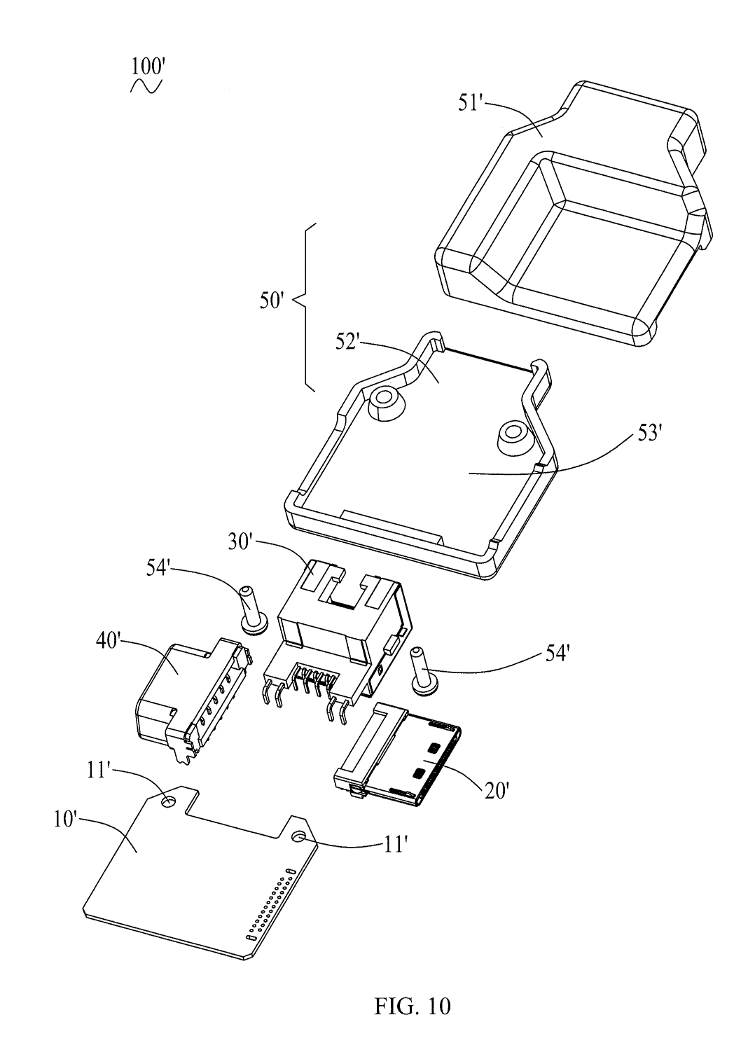

Referring to FIGS. 9-10, an adapter 100′ in accordance with a second embodiment of the present invention is shown. The adapter 100′ comprises a PCB 10′, a first connector 20′, a second connector 30′, and a third connector 40′. The first connector 20′, the second connector 30′ and the third connector 40′ all electrically connect with the PCB 10′ via three different directions. The adapter 100′ also comprises an insulative cover 50′ enclosing the PCB 10′, the first connector 20′, the second connector 30′, and the third connector 40′.

Referring to FIGS. 2 and 10, the adapter 100, 100′ in accordance with the present invention are substantially the same, and the only difference therebetween is: the insulative cover 50 is overmolded with the PCB 10, the first connector 20, the second connector 30, and the third connector 40; while the insulative cover 50′ is assembled to the PCB 10′, the first connector 20′, the second connector 30′, and the third connector 40′.

The insulative cover 50′ comprises an upper shell 51′ and a lower shell 52′. A receiving space 53′ is defined by the upper shell 51′ and the lower shell 52′ to receive the PCB 10′, the first connector 20′, the second connector 30′, and the third connector 40′. The adapter 100′ is also assembled with a plurality of screws 54′ which fasten the upper shell 51′ and the lower shell 52′ via protruding through screw holes 11′ defined in the PCB 10′. Via the engagement between the screws 54′ and the screw holes 11′, the upper shell 51′ and the lower shell 52′ are tightly assembled to the PCB 10′, the first connector 20′, the second connector 30′, and the third connector 40′.

Referring to FIGS. 1 and 9, the adapter 100, 100′ is of T-shape, however, in alternative embodiments, the adapter 100, 100′ also could be Y-shape or other alternative shapes to realize a multi-directional adaption of the adapter 100, 100′.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An adapter, comprising:
a PCB;
a first connector electrically connecting with the PCB;
a second connector electrically connecting with the PCB;
a third connector electrically connecting with the PCB; and
an insulative cover enclosing the first connector, the second connector, and the third connector; wherein
the first connector electrically connects with the PCB via a first direction, the second connector electrically connects with the PCB via a second direction; and the third connector electrically connects with the PCB via a third direction, and the first direction, the second direction and the third direction are different from one another.

2. The adapter as claimed in claim 1, wherein the shape of the insulative cover is a T-shaped or a Y-shaped structure.

3. The adapter as claimed in claim 1, wherein the height of the first connector is lower than those of the second and third connectors.

4. The adapter as claimed in claim 1, wherein the first connector has a first mating port of flat shape, the second connector has a second mating port of rectangular shape, and the third connector has a third mating port of trapezoidal shape.

5. The adapter as claimed in claim 4, wherein the first connector is of flat shape, the second connector is an RJ 45 connector, and the third connector is a VGA connector.

6. The adapter as claimed in claim 1, wherein the first connector has a plurality of first signal contacts grouped into a first group of first signal contacts and a second group of first signal contacts, and wherein the second connector has a plurality of second signal contacts electrically connect with the first group of first signal contacts, while the third connector has a plurality of third signal contacts electrically connect with the second group of first signal contacts.

7. The adapter as claimed in claim 6, wherein the number of the first group of first signal contacts is equal to that of the second group of first signal contacts.

8. The adapter as claimed in claim 6, wherein the first, second and third signal contacts of the respective first, second and third connectors are all soldered to the PCB.

9. The adapter as claimed in claim 1, wherein the insulative cover is of an integrated structure and overmolded with the first, second and third connectors.

10. The adapter as claimed in claim 1, wherein the insulative cover comprises an upper shell and lower shell which define a receiving space together to receive the PCB, the first, second and third connectors.

11. The adapter as claimed in claim 1, wherein the first connector comprises a first insulative housing and a plurality of first contacts received in the first insulative housing, the second connector comprises a second insulative housing and a plurality of second contacts received in the insulative housing, and the third connector comprises a third insulative housing and a plurality of third contacts received in the third insulative housing.

12. The adapter as claimed in claim 11, wherein the height of the first insulative housing is lower than those of the second insulative housing and the third insulative housing.

13. The adapter as claimed in claim 12, wherein the number of the first contacts is equal to the number of the second contacts plus the number of the third contacts.
